(19) United States
(12) Patent Application Publication
(10) Pub. No.: US 2019/0164537 A1
(43) Pub. Date: May 30, 2019

(54) SERVER, ELECTRONIC APPARATUS, CONTROL DEVICE, AND METHOD OF CONTROLLING ELECTRONIC APPARATUS

(71) Applicant: SHARP KABUSHIKI KAISHA, Sakai City (JP)

(72) Inventor: TAKUYA OYAIZU, Sakai City (JP)

(21) Appl. No.: 16/178,592

(22) Filed: Nov. 2, 2018

(30) Foreign Application Priority Data
Nov. 30, 2017 (JP) 2017-230812

(51) Int. Cl. G10L 15/08; G10L 17/22; G06Q 30/06

(52) U.S. Cl. CPC G10L 15/08; G10L 17/22; G10L 2015/088; G06Q 30/0633; G06Q 30/0631

(57) ABSTRACT

A keyword that is a word or phrase implying narrowing down of a certain option group is detected from a sound of a speech of a user and, based on the keyword, an option presenting sound that presents one or more options included in the option group to the user is generated as a response sound.

This Nonprovisional application claims priority under 35 U.S.C. § 119 on Patent Application No. 2017-230812 filed in Japan on Nov. 30, 2017, the entire contents of which are hereby incorporated by reference.

### TECHNICAL FIELD

One or more embodiments of the present invention relate to a server, an electronic apparatus, a control device, a control method, and a program, each of which presents options of merchandise or the like to a user.

### BACKGROUND ART

A purchase proxy system which allows a user to carry out a purchasing activity has been known. For example, Patent Literature 1 discloses a purchase proxy system. The purchase proxy system includes domestic equipment and a purchase proxy server. The domestic equipment includes a microphone that obtains voice data from a purchaser. The purchase proxy server includes: a purchase proxy section that detects the name of a purchaser's desired commodity from the voice data; and a storage section that stores commodity identification information in association with the name of the commodity for each purchaser. The purchase proxy section includes: an ordering commodity specification section that specifies commodity identification information corresponding to the detected name of the commodity; and an ordering section that places an order for the desired commodity by transmitting the commodity identification information to an order destination shop server.

### CITATION LIST

### Patent Literature

[Patent Literature 1]

Japanese Patent Application Publication Tokukai No. 2017-126223 (Publication date: Jul. 20, 2017)

### SUMMARY OF INVENTION

### Technical Problem

However, the above-described conventional technique is configured such that a display device displays a list of commodities thereon and that a user selects his/her desired commodity from the displayed list of commodities. One possible configuration to present options to a user only using audio without using a display device is to audibly read all the options one by one. Such a configuration may cause an issue in that, especially in a case where the number of options is large, the time taken for the reading is long and thus results in inconvenience. As such, according to such a conventional technique, it is not realistic to present a plurality of options using audio.

An object of one or more embodiments of the present invention is to provide an electronic apparatus which audibly presents options that a user desires, while maintaining convenience without using a display device or the like.

### Solution to Problem

In order to attain the above object, a server according to one or more embodiments of the present invention is a management server including a communication device and a control device, the communication device being configured to receive, from an electronic apparatus, a sound of a speech of a user, the sound of the speech being obtained by the electronic apparatus, and transmit, to the electronic apparatus, a response sound responding to the sound of the speech and cause the electronic apparatus to output the response sound, the control device being configured to detect, from the sound of the speech, a keyword that is a word or phrase implying narrowing down of a certain option group, and generate, based on the keyword, an option presenting sound which presents, to the user, one or more options included in the option group, the option presenting sound being the response sound.

An electronic apparatus according to one or more embodiments of the present invention is an electronic apparatus including: a sound input section configured to obtain a sound of a speech of a user; a sound output section configured to output a response sound responding to the sound of the speech; and a control device, the control device being configured to detect, from the sound of the speech obtained by the sound input section, a keyword that is a word or phrase implying narrowing down of a certain option group, and generate, based on the keyword, an option presenting sound which presents, to the user, one or more options included in the option group, the option presenting sound being the response sound.

A control device according to one or more embodiments of the present invention is a control device configured to control an electronic apparatus including: a sound input section configured to obtain a sound of a speech of a user; and a sound output section configured to output a response sound responding to the sound of the speech, the control device including: a keyword detecting section configured to detect, from the sound of the speech obtained by the sound input section, a keyword that is a word or phrase implying narrowing down of a certain option group, and a response generating section configured to generate, based on the keyword, an option presenting sound which presents, to the user, one or more options included in the option group, the option presenting sound being the response sound.

A method of controlling an electronic apparatus according to one or more embodiments of the present invention is a method of controlling an electronic apparatus that includes: a sound input section configured to obtain a sound of a speech of a user; and a sound output section configured to output a response sound responding to the sound of the speech, the method including: a keyword detecting step including detecting, from the sound of the speech obtained by the sound input section, a keyword that is a word or phrase implying narrowing down of a certain option group, and a response generating step including generating, based on the keyword, an option presenting sound which presents, to the user, one or more options included in the option group, the option presenting sound being the response sound.

### Advantageous Effects of Invention

According to one or more embodiments of the present invention, it is possible to narrow down the range of an option group while reflecting a user's desires, and to audibly present, to the user, an option(s) included in the narrowed range.

### BRIEF DESCRIPTION OF DRAWINGS

FIG. 1 is a block diagram illustrating one example configuration of main sections of a terminal apparatus and a management server in accordance with Embodiment 1 of the present invention.

FIG. 2 illustrates an overview of a merchandise presenting system in accordance with Embodiment 1 of the present invention.

FIG. 3 is a table showing one example of a data structure of related term correspondence information in accordance with Embodiment 1 of the present invention.

FIG. 4 is a flowchart illustrating one example of a flow of a process carried out by the merchandise presenting system in accordance with Embodiment 1 of the present invention.

FIG. 5 is a block diagram illustrating one example configuration of main sections of a terminal apparatus and a management server in accordance with Embodiment 2 of the present invention.

FIG. 6 is a flowchart illustrating one example of a flow of a process carried out by a merchandise presenting system in accordance with Embodiment 2 of the present invention.

FIG. 7 is a block diagram illustrating one example configuration of main sections of a terminal apparatus and a management server in accordance with Embodiment 3 of the present invention.

FIG. 8 is a flowchart illustrating one example of a flow of a process carried out by a merchandise presenting system in accordance with Embodiment 3 of the present invention.

FIG. 9 is a block diagram illustrating one example configuration of main sections of a terminal apparatus and a management server in accordance with Embodiment 4 of the present invention.

FIG. 10 is a flowchart illustrating one example of a flow of a process carried out by a merchandise presenting system in accordance with Embodiment 4 of the present invention.

### DESCRIPTION OF EMBODIMENTS

### Embodiment 1

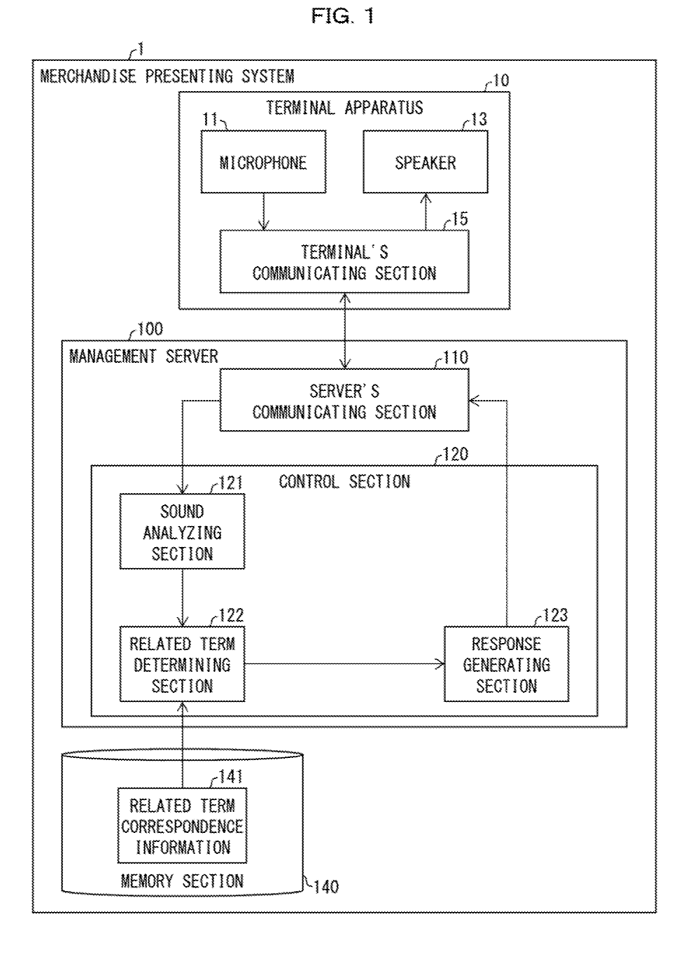

The following description will discuss one embodiment of the present invention with reference to FIGS. 1 to 3.

[Overview of Merchandise Presenting System 1]

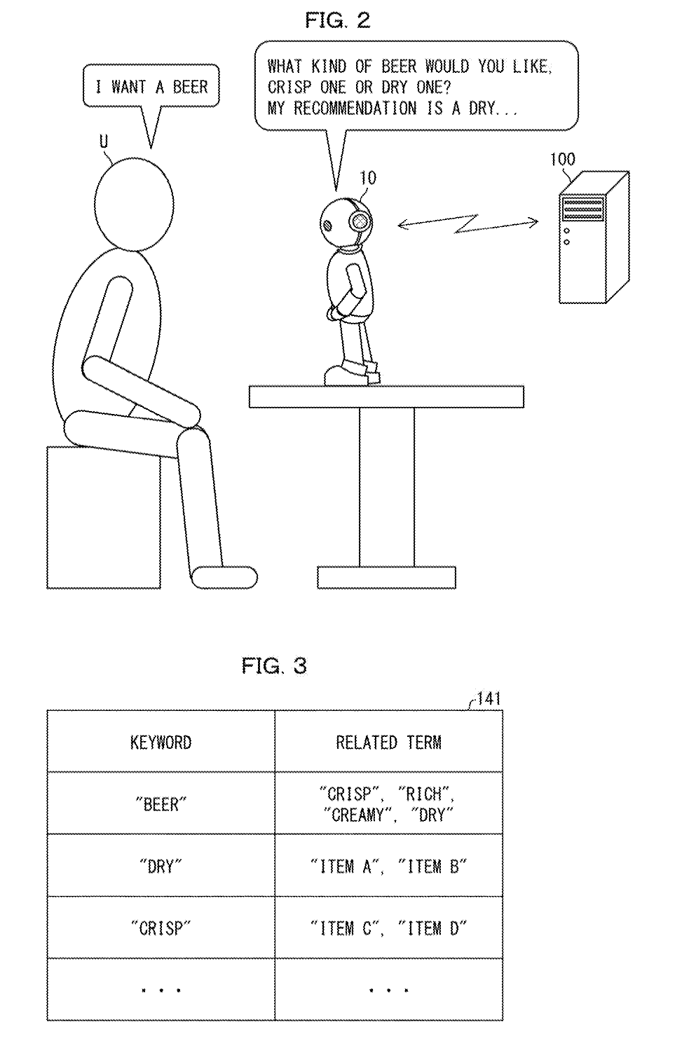

First of all, an overview of a merchandise presenting system 1 in accordance with Embodiment 1 is described with reference to FIG. 2. FIG. 2 illustrates the overview of the merchandise presenting system 1. As illustrated in FIG. 2, the merchandise presenting system 1 includes a terminal apparatus (electronic apparatus) 10 and a management server (server) 100.

The management server 100 in accordance with Embodiment 1 receives a sound of a speech of a user U obtained by the terminal apparatus 10. The management server 100 detects a keyword that is contained in the sound of the speech from the user U and that is a word or phrase implying narrowing down of an option group. As used herein, the term “option group” refers to a word group including: a certain word or phrase (for example, a word or phrase indicative of a merchandise category, such as “beverage”); and words and/or phrases directly or indirectly related to the certain word or phrase (for example, the word “beer”, the word “dry” which is subordinate to the “beer”, specific merchandise names of beers, and the like). The management server 100 generates a response sound based on the keyword. The response sound is an option presenting sound that presents, to the user U, one or more options included in the option group. Then, the management server 100 causes the terminal apparatus 10 to output the response sound, which responds to the sound of the speech of the user U.

For example, as illustrated in FIG. 2, the management server 100 detects the keyword “beer” contained in the sound of the speech “I want a beer” of the user U. Next, the management server 100 causes, based on the keyword “beer”, the terminal apparatus 10 to output the sound “What kind of beer would you like, crisp one or dry one? My recommendation is a dry . . . ”. The terms “crisp” and “dry” contained in the sound are options related to (i.e., associated with) the keyword “beer”. In this specification, a “word or phrase” that is associated with a certain keyword and that is indicative of an option included in a certain option group is referred to as a “related term” of that keyword. For example, in the above-described example, the related terms of the keyword “beer” are the terms “crisp” and “dry”, which are two options included in a certain option group (for example, a beer-related option group).

According to the above configuration, based on the term “beer” which is an abstract word indicated by the user, the management server 100 narrows down multiple option groups to the option (option group) “crisp” or “dry”, which may be included in two or more option groups and which is presented to the user. Then, the management server 100 audibly presents the option “crisp” or the option “dry” to the user, each of which is an option resulted from the narrowing down. This makes it possible to provide audio guidance that enables narrowing down of options to suit the user's desires, while maintaining convenience without using a display device or the like.

For example, the following arrangement may be employed: conversation like that described above between a user and the terminal apparatus 10 is carried out a plurality of times, and thereby the options are narrowed down to one merchandise item included in the option group. In this case, the terms “crisp” and “dry” serve both as related terms and as keywords. Each of the keywords “crisp” and “dry” may be associated with one or more merchandise names.

According to the foregoing arrangement, narrowing down of merchandise items is carried out based on a user's implication that does not specifically indicate any merchandise name. As such, the management server 100 is capable of presenting a newly released merchandise item or the like whose name is unknown to the user, and also enables the user to select a merchandise item whose name is unknown to the user.

(Configuration of Terminal Apparatus 10)

The following description will discuss a configuration of the terminal apparatus 10 with reference to FIG. 1. FIG. 1 is a block diagram illustrating a configuration of main sections of the terminal apparatus 10 and the management server 100. As illustrated in FIG. 1, the terminal apparatus 10 includes a microphone (sound input section) 11, a speaker (sound output section) 13, and a terminal's communicating section 15. The microphone 11 serves to collect sounds and the like. The microphone 11 transmits, to the terminal's communicating section 15, the collected sound as audio data. The speaker 13 audibly provides a notification or the like to a user. The speaker 13 audibly provides, to the user, the audio data received from the terminal's communicating section 15. The terminal's communicating section 15 communicates with the management server 100. For example, the terminal's communicating section 15 may communicate with the management server 100 over the Internet or the like. The terminal's communicating section 15 transmits, to the management server 100, the audio data received from the microphone 11. The terminal's communicating section 15 also transmits, to the speaker 13, a response sound responding to the sound of the speech of the user U. The response sound is received from the management server 100.

(Configuration of Management Server 100)

The following description will discuss a configuration of the management server 100 with reference to FIG. 1. As illustrated in FIG. 1, the management server 100 includes a server's communicating section (communication device) 110, a control section (control device) 120, and a memory section 140.

(Server's Communicating Section 110)

The server's communicating section 110 receives, from the terminal apparatus 10, the sound of the speech of the user U obtained by the terminal apparatus 10. The server's communicating section 110 also transmits, to the terminal apparatus 10, the response sound responding to the sound of the speech of the user U, and causes the terminal apparatus 10 to output the response sound.

(Control Section 120)

The control section 120 serves to control the management server 100 in an integrated manner. The control section 120 includes a sound analyzing section 121, a related term determining section (keyword detecting section) 122, and a response generating section 123.

(Sound Analyzing Section 121)

The sound analyzing section 121 generates text data from the audio data which has been received from the microphone 11. Specifically, the sound analyzing section 121 analyzes and identifies the content of the speech of the user. The sound analyzing section 121 transmits the generated text data to the related term determining section 122.

(Related Term Determining Section 122)

The related term determining section 122 detects, from the text data received from the sound analyzing section 121, a keyword that is a word or phrase implying narrowing down of a certain option group. The detection of a keyword may be carried out by, for example, pattern matching. In a case where the “text data” is “I want a beer” like the foregoing example, the related term determining section 122 detects the keyword “beer” that is contained in the text data, for example.

The related term determining section 122 also determines a related term(s) associated with the detected keyword. For example, the related term determining section 122 may reference related term correspondence information 141 stored in the memory section 140 to determine the related term(s). The related term correspondence information 141 may indicate a relationship between a certain keyword and its corresponding related term(s).

The related term correspondence information 141 is described below with reference to FIG. 3. FIG. 3 is a table showing one example of a data structure of the related term correspondence information 141. As illustrated in FIG. 3, for example, the keyword “beer” is associated with related terms such as “crisp”, “rich”, “creamy”, and “dry”. These terms may also serve as keywords. The keywords “dry”, “crisp”, and the like are each associated with two or more related terms, which are merchandise names.

The related term determining section 122 transmits, to the response generating section 123, the detected keyword and the determined related term(s).

The related term determining section 122 may detect, from the text data, a merchandise name selected by the user and transmit the merchandise name to the response generating section 123.

(Response Generating Section 123)

The response generating section 123 generates the response sound based on the keyword. The response sound is an option presenting sound that presents, to the user, one or more options included in the option group. The response generating section 123 transmits the response sound to the terminal apparatus 10 via the server's communicating section 110, and causes the terminal apparatus 10 to output the response sound.

Specifically, the response generating section 123 generates a response sound responding to the sound of the speech of the user such that the response sound contains the related term(s) associated with the keyword received from the related term determining section 122. For example, assume that the response generating section 123 has received the keyword “beer” and the related terms “crisp”, “rich”, “creamy”, and “dry”. The response generating section 123 generates the response sound “OK, what kind of beer would you like, crisp one, rich one, creamy one, or dry one? My recommendation is Merchandise Item A, which is a dry beer.” That is, the response generating section 123 generates audio data that prompts the user to select any of the related terms contained in the response sound. In other words, the response generating section 123 generates a response sound that prompts the user to select any of the option groups included in the option group “beer”. The response generating section 123 may further receive text data from the sound analyzing section 121 and cause back-channel feedback to the user to be contained in the response sound. The following arrangement may also be employed: some other keyword such as the phase “I'm thirsty” is detected; and related terms indicative of a beverage category such as “beer” and “juice” are associated with the keyword.

The above arrangement can also be represented as below. The response generating section 123 narrows down options included in the option group to more specific options, based on the keyword. If the number of options resulted from the narrowing down is equal to or more than a predetermined number, then the response generating section 123 generates, as the response sound, an option-narrowing prompting sound for prompting a user to speak another related term that enables further narrowing down of the options.

Note, here, that the audio data may contain, at its end, a sound indicative of a recommendation of a specific merchandise item, such as “My recommendation is Merchandise Item A, which is a dry beer”, as in the foregoing arrangement. In other words, the response generating section 123 generates, if the number of options resulted from the narrowing down is two or more, a response sound which is an option-narrowing prompting sound containing, at its end, a sound that presents one of the options resulted from the narrowing down. Since the response generating section 123 adds the sound “My recommendation is Merchandise Item A, which is a dry beer” at the end of the audio data that it generates, a recommended merchandise item can be presented to a user without obvious sales talk. The response generating section 123 may also generate a response sound that indicates the acceptance of a selection of a merchandise item made by a user's speech.

(Memory Section 140)

The memory section 140 is a non-volatile storage medium such as a hard disk, a flash memory, or the like. The memory section 140 stores therein various kinds of information such as the foregoing related term correspondence information 141.

(Flow of Process Carried Out by Merchandise Presenting System 1)

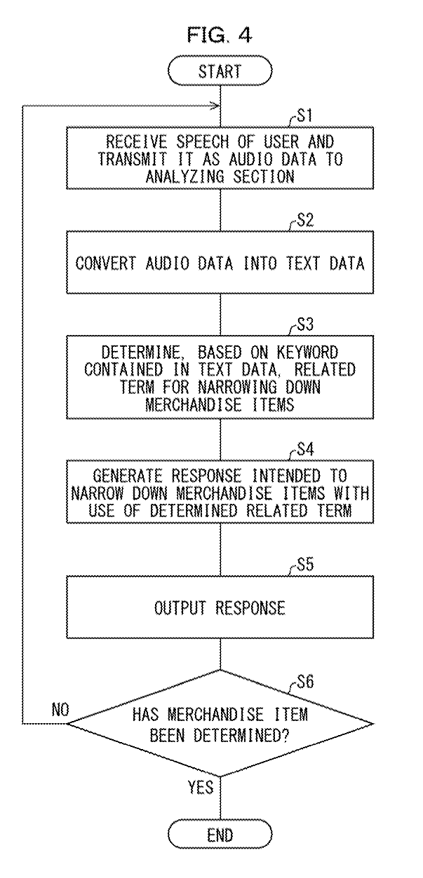

The following description will discuss a flow of a process carried out by the merchandise presenting system 1, with reference to FIG. 4. FIG. 4 is a flowchart illustrating one example of the flow of the process carried out by the merchandise presenting system 1. For example, the merchandise presenting system 1 starts its process with a collection, by the microphone 11 of the terminal apparatus 10, of a sound of a speech of a user. The terminal apparatus 10 transmits, to the management server 100, audio data indicative of the sound of the speech of the user (step S1). Next, the sound analyzing section 121 of the management server 100 generates text data from the audio data (i.e., converts the audio data into text data) (step S2). Next, the related term determining section 122 detects a keyword contained in the text data (this step is keyword detecting step), and determines a related term based on the keyword (step S3). Next, the response generating section 123 generates, based on the determined related term and the keyword, a response sound intended to narrow down merchandise items (step S4: response generating step). Next, the speaker 13 of the terminal apparatus 10 outputs the response sound received from the management server 100 (step S5). If a merchandise item has been determined (YES in step S6), the process carried out by the merchandise presenting system 1 ends. On the other hand, if a merchandise item has not been determined (NO in step S6), the process carried out by the merchandise presenting system 1 returns to step S1.

### Embodiment 2

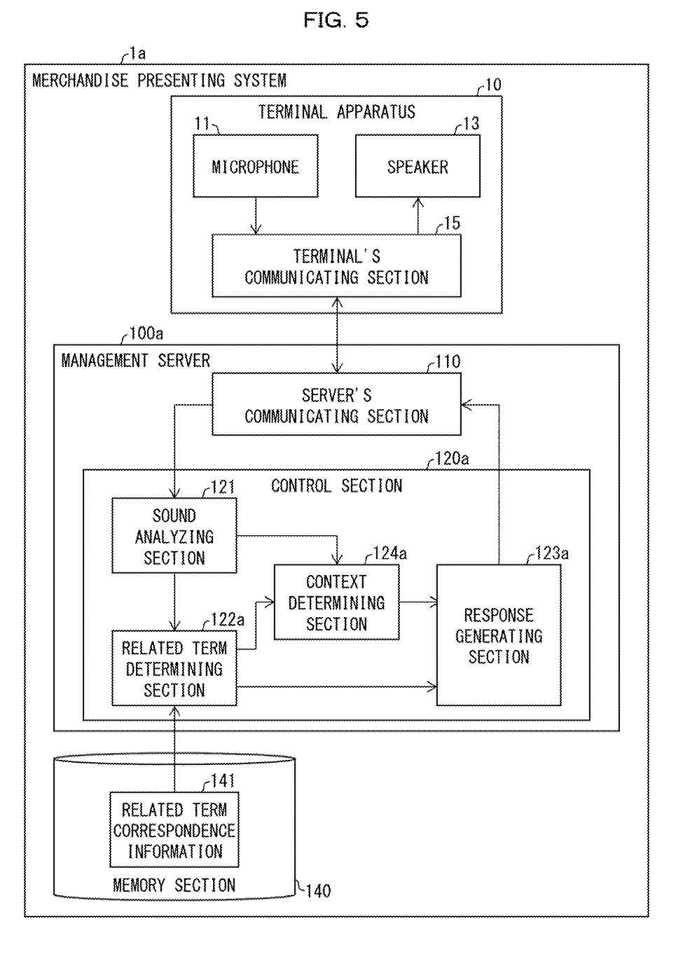

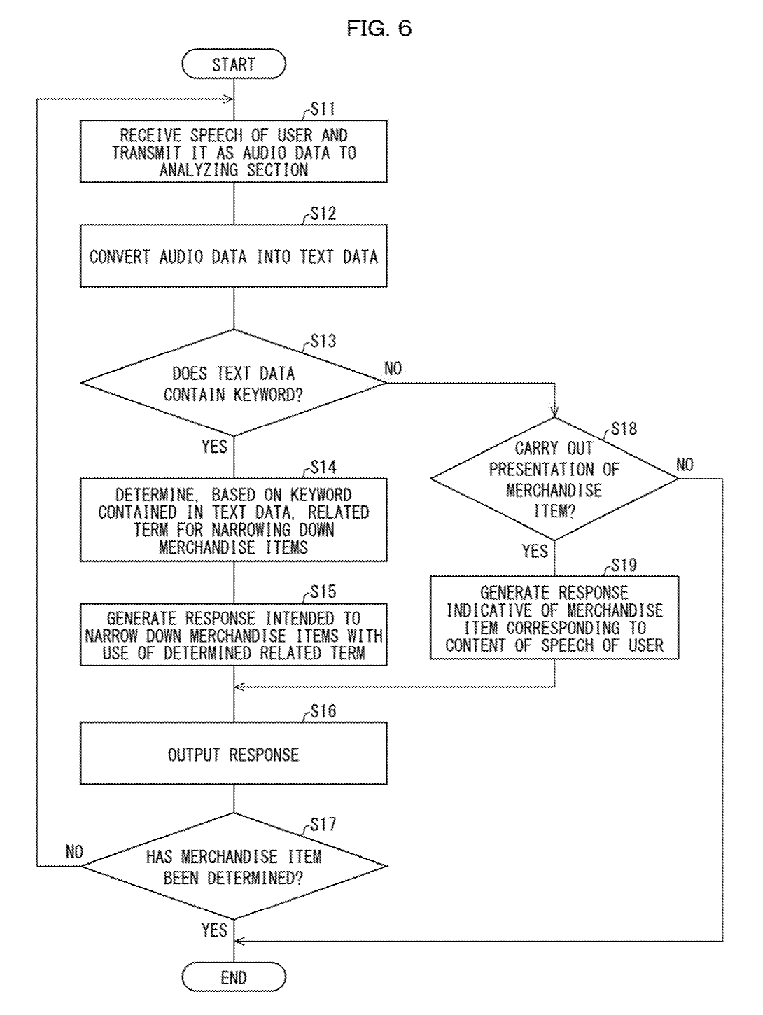

The following description will discuss another embodiment of the present invention with reference to FIGS. 5 and 6. For convenience of description, members having functions identical to those of Embodiment 1 are assigned identical referential numerals and their descriptions are omitted.

(Configuration of Merchandise Presenting System 1a)

A merchandise presenting system 1a in accordance with Embodiment 2 includes a terminal apparatus 10 and a management server 100a. The terminal apparatus 10 has the same configuration as that described in Embodiment 1, and therefore its descriptions are omitted here.

The management server 100a determines, based on the content of a speech of a user, whether or not to carry out presentation of one or more options included in an option group to the user. If it is determined to carry out presentation of one or more options included in the option group to the user, the management server 100a generates the foregoing option presenting sound as a response sound. According to this configuration, it is possible to present an option(s) when deemed appropriate during the conversation.

(Configuration of Management Server 100a)

The following description will discuss a configuration of the management server 100a in accordance with Embodiment 2, with reference to FIG. 5. FIG. 5 is a block diagram illustrating a configuration of main sections of the terminal apparatus 10 and the management server 100a. As illustrated in FIG. 5, the management server 100a includes a server's communicating section 110, a control section 120a, and a memory section 140. The server's communicating section 110 and the memory section 140 have the same configurations as those described in Embodiment 1, and therefore their descriptions are omitted here.

(Control Section 120a)

The control section 120a includes a sound analyzing section 121, a related term determining section 122a, a response generating section 123a, and a context determining section 124a (presentation allow/disallow determining section). The sound analyzing section 121 has the same function as the sound analyzing section 121 described in Embodiment 1 and, in addition, serves to transmit, to the context determining section 124a, text data generated from the audio data.

(Related Term Determining Section 122a)

The related term determining section 122a determines whether or not the text data received from the sound analyzing section 121 contains a keyword. If it is determined that the text data contains a keyword, the related term determining section 122a carries out the same process as that of the related term determining section 122 described in Embodiment 1. If it is determined that the text data contains no keywords, then the related term determining section 122a transmits, to the context determining section 124a, a signal indicating that no related terms have been determined.

(Context Determining Section 124a)

The context determining section 124a determines, based on the text data received from the sound analyzing section 121, whether or not to carry out presentation of one or more options in an option group to the user. If it is determined to carry out presentation of one or more options in the option group to the user, the context determining section 124a transmits, to the response generating section 123a, a signal indicative of the one or more options.

The context determining section 124a may be constituted by artificial intelligence (AI). For example, the context determining section 124a may determine whether or not a certain word or phrase such as the phrase “It's hot today” is contained in the content of a speech. The context determining section 124a may determine to carry out presentation of one or more options in an option group to the user if a certain word or phrase is contained in the content of the speech. For example, the phrase “It's hot today” is associated with a certain merchandise category (e.g., beer). The context determining section 124a may reference a table, which contains certain words and their corresponding merchandise categories, to carry out the determination.

Furthermore, the following arrangement may be employed: the context determining section 124a detects a certain word set such as a set of “mouth” and “dry” from a phrase such as “My mouth is dry” and determines that a user wants something to drink, and thereby determines to present a merchandise item which is a beverage.

Alternatively, the following arrangement may be employed: the context determining section 124a identifies, based on the audio data received from the terminal apparatus 10, the content of a speech of the user.

The management server 100a may obtain one or more kinds of information concerning a user or an environment around the user. The context determining section 124a may determine, based on the one or more kinds of information, whether or not to carry out presentation of one or more options in an option group to the user. Examples of the one or more kinds of information include the temperature of a room, weather, content of a speech of the user, history of selected options, operational status of some other equipment present near the user (e.g., settings of air conditioner), and the like. The one or more kinds of information may be obtained by the terminal apparatus 10 and transmitted from the terminal apparatus 10 to the management server 100a. Alternatively, the one or more kinds of information may be obtained by at least one of the management server 100a and the terminal apparatus 10.

(Response Generating Section 123a)

The response generating section 123a has the function of the response generating section 123 described in Embodiment 1 and, in addition, serves to carry out the following process. The response generating section 123a generates, if it is determined by the context determining section 124a to carry out presentation of one or more options in an option group to the user, an option presenting sound that presents the one or more options. Specifically, the response generating section 123a generates an option presenting sound that presents the one or more options indicated by the signal received from the context determining section 124a, and causes the speaker 13 to output the response sound. For example, upon receiving from the context determining section 124a a signal indicative of an option (a specific kind of beer), the response generating section 123a generates a response sound indicative of the specific kind of beer, which is, for example, as follows: “Then, how about a XX beer? The XX beer has a good reputation from customers for its crisp and dry taste.” It should be noted that the response generating section 123a may receive, from the context determining section 124a, a signal indicative of a plurality of keywords corresponding to respective option groups each including a plurality of options. In this case, the response generating section 123a generates a response sound that prompts the user to select one of the plurality of keywords.

(Flow of Process Carried Out by Merchandise Presenting System 1a)

The following description will discuss a flow of a process carried out by the merchandise presenting system 1a, with reference to FIG. 6. FIG. 6 is a flowchart illustrating one example of the flow of the process carried out by the merchandise presenting system 1a. Step S11 is the same as step S1 of Embodiment 1 and step S12 is the same as step S2 of Embodiment 1, and therefore their descriptions are omitted here. After step S12, the related term determining section 122a determines whether or not text data contains a keyword (step S13). If it is determined that the text data contains a keyword (YES in step S13), then the process proceeds to step S14. Steps S14 to S16 are the same as steps S3 to S6 described in Embodiment 1, respectively, and therefore their descriptions are omitted here. After step S16, if a merchandise item has been determined (YES in step S17), the process ends. If a merchandise item has not been determined (NO in step S17), the process returns to step S11.

If it is determined that the text data contains no keywords (NO in step S13), the context determining section 124a determines whether or not to carry out presentation of a merchandise item(s) (i.e., whether or not to carry out presentation of one or more options in an option group to the user) (step S18). If it is determined to carry out presentation of a merchandise item(s) (YES in step S18), the response generating section 123a generates a response sound indicative of a merchandise item(s) corresponding to the content of the speech of the user (step S19). Then, the process proceeds to step S16.

### Embodiment 3

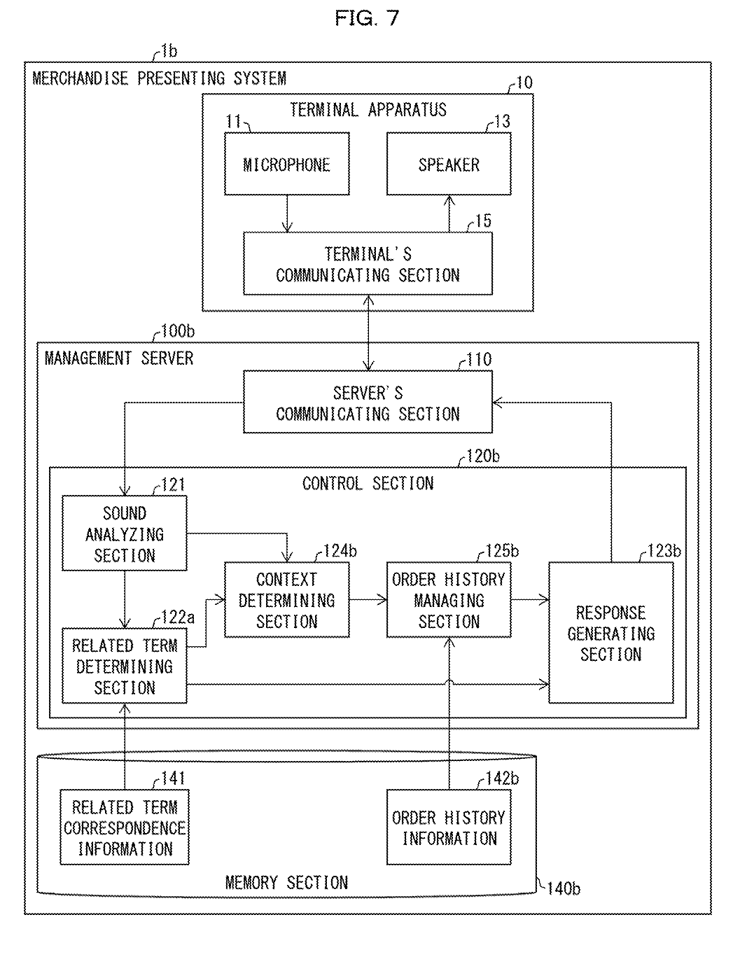

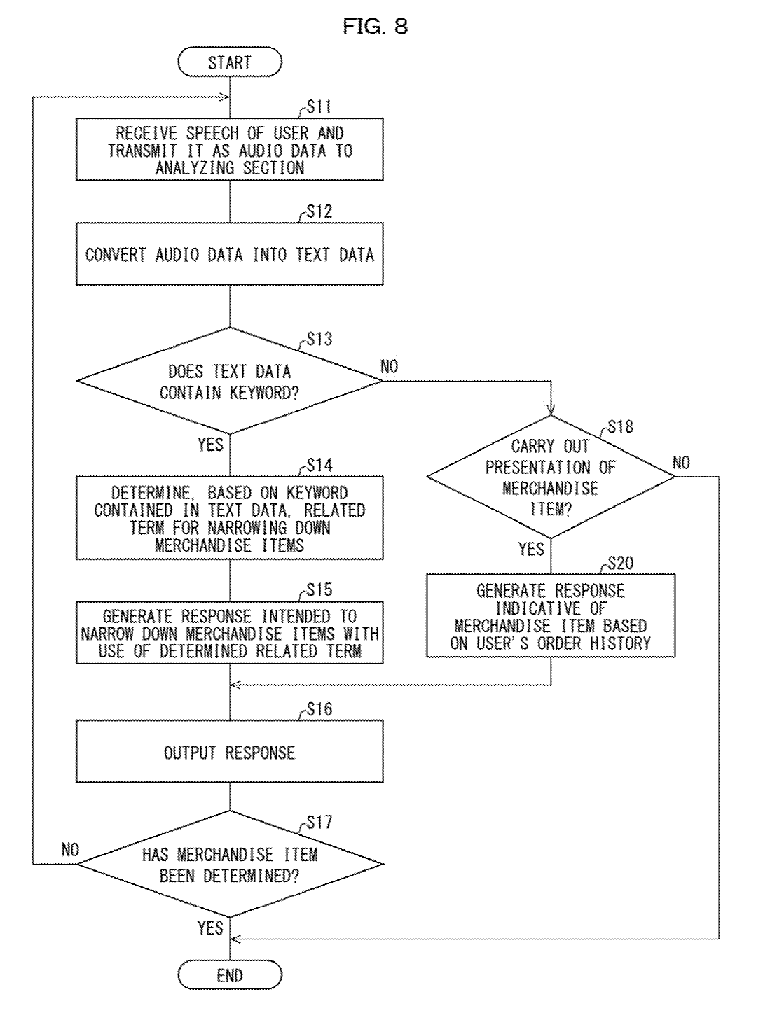

The following description will discuss a further embodiment of the present invention with reference to FIGS. 7 and 8. For convenience of description, members having functions identical to those of Embodiments 1 and 2 are assigned identical referential numerals and their descriptions are omitted.

(Configuration of Merchandise Presenting System 1b)

A merchandise presenting system 1b in accordance with Embodiment 3 includes a terminal apparatus 10 and a management server 100b. The terminal apparatus 10 has the same configuration as that described in Embodiment 1, and therefore its descriptions are omitted here.

The management server 100b determines, based on a history of a user's selection of options (which serves as the foregoing one or more kinds of information), whether or not to carry out presentation of one or more options in an option group to a user.

Specifically, the management server 100b presents, based on the user's order history, a merchandise item that the user has ordered before. In other words, each of the merchandise items included in an option group is determined by the management server 100b as to whether it is to be presented to the user, based on the user's order history. This configuration makes it possible to present, to the user, an option that is highly likely to suit the user's desires.

(Configuration of Management Server 100b)

The following description will discuss a configuration of the management server 100b in accordance with Embodiment 3, with reference to FIG. 7. FIG. 7 is a block diagram illustrating a configuration of main sections of the terminal apparatus 10 and the management server 100b. As illustrated in FIG. 7, the management server 100b includes a server's communicating section 110, a control section 120b, and a memory section 140b. The server's communicating section 110 has the same configuration as that described in Embodiment 1, and therefore its descriptions are omitted here. The memory section 140b has the function of the memory section 140 described in Embodiment 1 and, in addition, stores therein order history information 142b indicative of a user's order history.

(Control Section 120b)

The control section 120b includes a sound analyzing section 121, a related term determining section 122a, a response generating section 123b, a context determining section 124b, and an order history managing section 125b. The sound analyzing section 121 and the related term determining section 122a are the same as the sound analyzing section 121 and the related term determining section 122a described in Embodiment 2, respectively, and therefore their descriptions are omitted here.

(Context Determining Section 124b)

The context determining section 124b has the function of the context determining section 124a and, in addition, serves to carry out the following process. If it is determined to carry out presentation of one or more options in an option group to a user, the context determining section 124b instructs the order history managing section 125b to determine which option to present to the user.

(Order History Managing Section 125b)

The order history managing section 125b determines whether or not to carry out presentation of one or more options in an option group to the user based on the user's order history.

Specifically, the order history managing section 125b selects one option from the option group, based on the user's order history. For example, the order history managing section 125b references order history information 142b and selects a merchandise item contained in the order history information 142b. The order history managing section 125b transmits, to the response generating section 123b, a signal indicative of the selected merchandise item.

(Response Generating Section 123b)

The response generating section 123b has the function of the response generating section 123a described in Embodiment 2 and, in addition, carries out the following process. The response generating section 123b generates, as a response sound, an option presenting sound that presents, to the user, the one option indicated by the signal received from the order history managing section 125b.

(Flow of Process Carried Out by Merchandise Presenting System 1b)

The following description will discuss one example of a flow of a process carried out by the merchandise presenting system 1b, with reference to FIG. 8. FIG. 8 is a flowchart illustrating one example of the flow of the process carried out by the merchandise presenting system 1b. Note that steps S11 to S18 are the same as those described in detail in Embodiment 2, and therefore their detailed descriptions are omitted here. In Embodiment 3, if it is determined by the context determining section 124b to carry out presentation of a merchandise item(s) (YES in step S18), the response generating section 123b generates a response sound that is indicative of a merchandise item(s) based on the user's order history (step S20).

The following description discusses one specific example of the flow of the process. It should be noted that, unlike Embodiment 1, this example is based on the assumption that the term “beer” contained in the speech of the user is not a keyword that has related terms associated therewith.

For example, assume that, in step S11, the terminal apparatus 10 has received the speech “Order a beer” from a user. Then, in step S13, the related term determining section 122a determines that no keywords are contained in text data (NO in step S13). Next, in step S18, the context determining section 124a determines to carry out presentation of a “beer”. Next, the order history managing section 125b references the order history information 142b to select a merchandise item (Brand A) that can be first presented. Next, in step S20, the response generating section 123b generates a response sound such as “Then, how about ‘Brand A’, which you have ordered before?”.

(Detailed Example of Process Carried Out by Order History Managing Section 125b)

The following description will discuss an example of a specific process carried out by the order history managing section 125b. The order history managing section 125b may reference the order history information 142b and select a merchandise item that the user has ordered most frequently within a certain period of time (e.g., for the past week, for the past month, for the past year).

Alternatively, the order history managing section 125b may select a merchandise item that is similar to a merchandise item that the user has ordered before. Such a similar merchandise item is, for example, a newly released beer that tastes similar to a beer that the user has ordered before.

### Embodiment 4

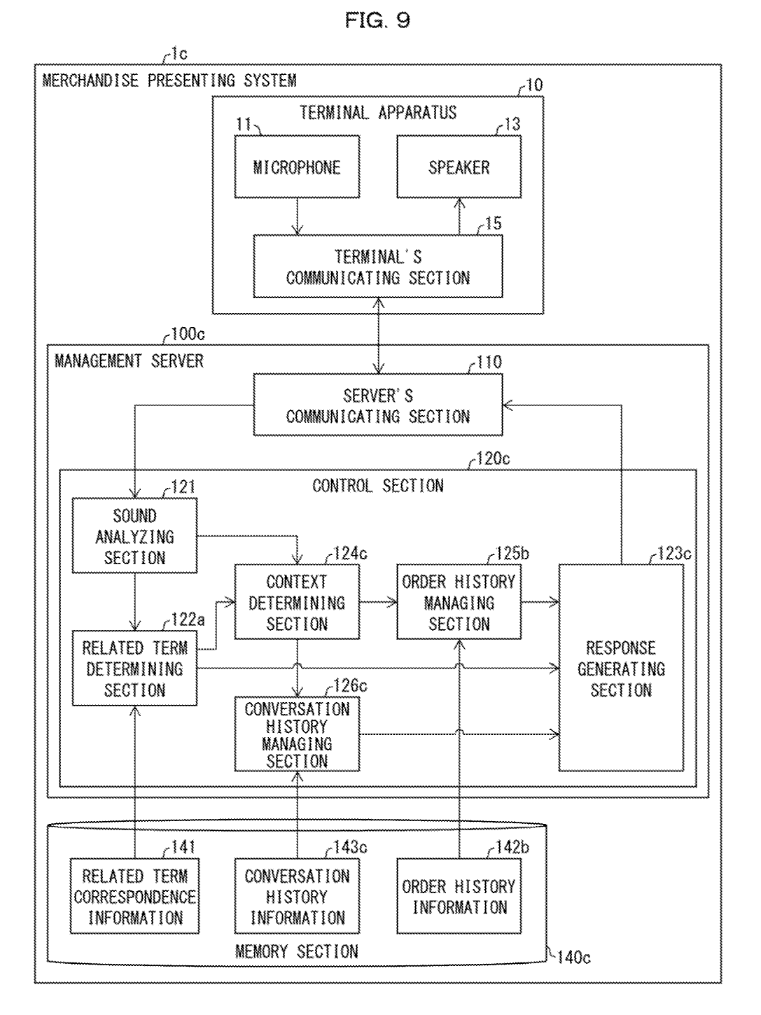

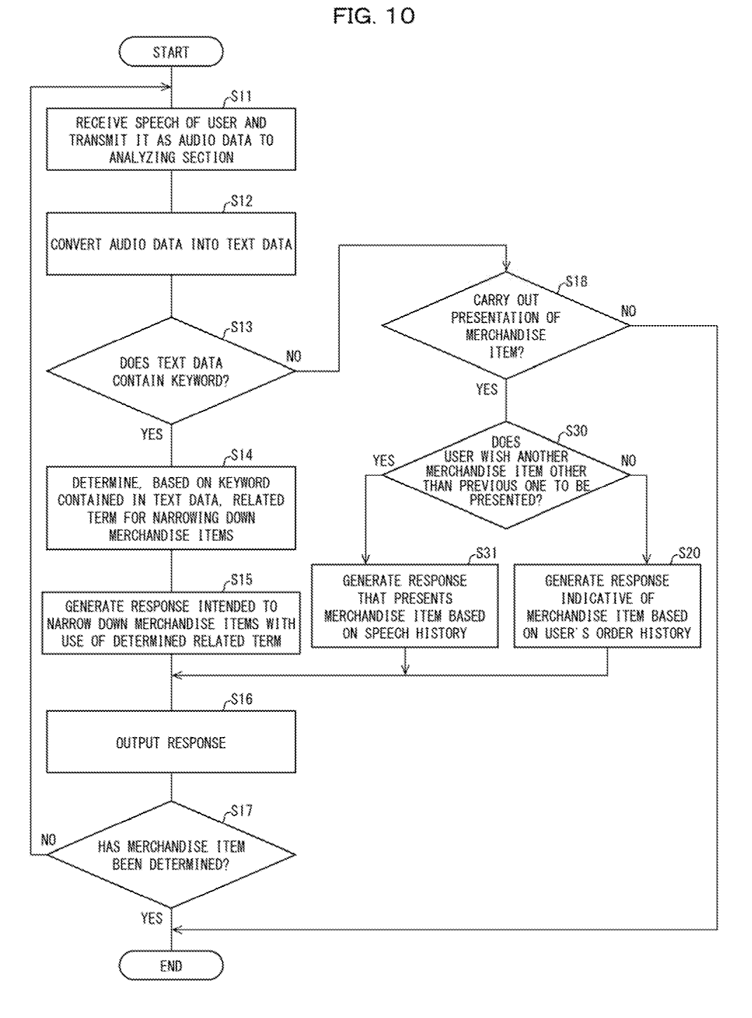

The following description will discuss still a further embodiment of the present invention with reference to FIGS. 9 and 10. For convenience of description, members having functions identical to those of Embodiments 1 to 3 are assigned identical referential numerals and their descriptions are omitted.

(Configuration of Merchandise Presenting System 1c)

A merchandise presenting system 1c in accordance with Embodiment 4 includes a terminal apparatus 10 and a management server 100c. The terminal apparatus 10 has the same configuration as that described in Embodiment 1, and therefore its descriptions are omitted here.

The management server 100c determines whether or not a sound of a speech of a user contains an instruction to present another option other than the option(s) contained in the previously-generated option presenting sound. If it is determined that the sound of the speech of the user contains an instruction to present another option, the management server 100c generates an option presenting sound that contains another option other than the option(s) contained in the previously-generated option presenting sound.

According to the configuration, the management server 100c is capable of, when the user wishes another option other than the option(s) presented by the management server 100c, receiving an instruction to present a different option. This improves convenience for the user.

(Configuration of Management Server 100c)

The following description will discuss a configuration of the management server 100c in accordance with Embodiment 4, with reference to FIG. 9. FIG. 9 is a block diagram illustrating a configuration of main sections of the terminal apparatus 10 and the management server 100c. As illustrated in FIG. 9, the management server 100c includes a server's communicating section 110, a control section 120c, and a memory section 140c. The server's communicating section 110 has the same configuration as that described in Embodiment 1, and therefore its descriptions are omitted here. The memory section 140c has the function of the memory section 140b described in Embodiment 3 and, in addition, stores therein conversation history information 143c indicative of a history of content of conversation between the user and the terminal apparatus 10.

(Control Section 120c)

The control section 120c includes a sound analyzing section 121, a related term determining section 122a, a response generating section 123c, a context determining section 124c, an order history managing section 125b, and a conversation history managing section 126c. The sound analyzing section 121, the related term determining section 122a, and the order history managing section 125b are the same as those described in Embodiment 3, and therefore their descriptions are omitted here.

(Context Determining Section 124c)

The context determining section 124c has the function of the context determining section 124b described in Embodiment 3 and, in addition, carries out the following process. The context determining section 124c determines whether or not a speech of a user contains an instruction to present another option other than the option(s) contained in the previously-generated option presenting sound. If it is determined that the speech of the user contains an instruction to present another option other than the option(s) contained in the previously-generated option presenting sound, the context determining section 124c instructs the conversation history managing section 126c to determine which option to include in a response sound that is to be generated.

(Conversation History Managing Section 126c)

Upon receiving the instruction from the context determining section 124c, the conversation history managing section 126c references the conversation history information 143c or the like and selects an option that is different from the option(s) contained in the previously-generated option presenting sound. The conversation history managing section 126c transmits, to the response generating section 123c, a signal indicative of the selected merchandise item.

(Response Generating Section 123c)

The response generating section 123c has the function of the response generating section 123b described in Embodiment 3 and, in addition, carries out the following process. The response generating section 123c generates an option presenting sound that presents, to the user, one option indicated by the signal received from the conversation history managing section 126c. Specifically, the response generating section 123c generates, as an option presenting sound, a response sound that contains an option different from the option(s) contained in the previously-generated option presenting sound.

(Flow of Process Carried Out by Merchandise Presenting System 1c)

The following description will discuss one example of a flow of a process carried out by the merchandise presenting system 1c, with reference to FIG. 10. FIG. 10 is a flowchart illustrating one example of the flow of the process carried out by the merchandise presenting system 1c. Note that steps S11 to S18 are the same as those described in detail in Embodiment 2, and therefore their detailed descriptions are omitted here. If it is determined by the context determining section 124c to carry out presentation of a merchandise item(s) (YES in step S18), the context determining section 124c further carries out the following determination in step S30. The context determining section 124c determines whether or not a speech of a user contains an instruction to present another option that is other than the option(s) contained in the previously-generated option presenting sound (step S30). If it is determined that the speech of the user contains an instruction to present another option (YES in step S30), the conversation history managing section 126c selects an option based on the conversation history information 143c. Next, in step S20, the response generating section 123c generates a response sound that presents the option selected by the conversation history information 143c (step S31). The process then proceeds to step S16. Note that, if it is determined that the speech of the user does not contain any instruction to present another option (NO in step S30), the process proceeds to step S20. Step S20 is the same as that described in Embodiment 3, and its descriptions are omitted here.

The following description will discuss a specific example of a flow of a process in accordance with Embodiment 4. In this example, the process subsequent to the specific process flow exemplarily discussed in Embodiment 3 is discussed. As described in Embodiment 3, in step S20, the response generating section 123c generates a response sound such as “Then, how about ‘Brand A’, which you have ordered before?”.

Next, in step S16, the terminal apparatus 10 outputs the response sound. Assume here that, in response to the response sound, the user speaks “I want something else”. In this case, in step S30, the context determining section 124c determines that the speech of the user contains an instruction to present another option other than the option “Brand A” contained in the previously-generated option presenting sound. Next, the conversation history managing section 126c selects “Brand B”, which is other than the previously presented “Brand A”, based on the conversation history information 143c. Note, here, that the conversation history information 143c may reference order history information 142b and select the merchandise item that the user has ordered second most frequently within a certain period of time. A specific method of the selection may be any method, and is not particularly limited. Next, in step S31, the response generating section 123c generates a response sound such as “Then, how about ‘Brand B’?”. Next, in step S16, the terminal apparatus 10 outputs the response sound.

Assume that, in response to the response sound, the user speaks “I prefer the previous one.” In this case, in step S30, the context determining section 124c determines that the speech of the user contains an instruction to present another option other than the option “Brand B” contained in the previously-generated option presenting sound. For example, the context determining section 124c instructs the conversation history managing section 126c to select the option contained in the response sound generated before the previously-generated response sound. Next, the conversation history managing section 126c selects “Brand A”, which is the option contained in the response sound generated before the previously-generated response sound. Next, in step S31, the response generating section 123c generates a response sound such as “OK, ‘Brand A’ is XXX yen. Would you like to buy it?”.

The foregoing Embodiments 1 to 4 discussed configurations in which one or more embodiments of the present invention are applied to a merchandise presenting system. Note, however, that a configuration of one or more embodiments of the present invention may be applied to, for example, a content provider service that provides movie, music, and/or the like and may be used to narrow down the content to suit the user's desires.

Furthermore, in the configurations of the foregoing Embodiments 1 to 4, the terminal apparatus 10 is provided separately from the management server 100, 100a, 100b, or 100c. Note, however, that, in some embodiments, the present invention may be applied to a merchandise presenting apparatus (electronic apparatus) in which the terminal apparatus 10 is integral with the management server 100, 100a, 100b, or 100c.

[Software Implementation Example]

Control blocks of the management servers 100 and 100a to 100c (particularly, the sound analyzing section 121, the related term determining sections 122 and 122a, the response generating sections 123 and 123a to 123c, the context determining sections 124a to 124c, the order history managing section 125b, and the conversation history managing section 126c) can be realized by a logic circuit (hardware) provided in an integrated circuit (IC chip) or the like or can be alternatively realized by software.

In the latter case, the management servers 100 and 100a to 100c each include a computer that executes instructions of a program that is software realizing the foregoing functions. The computer includes, for example, at least one processor (control device) and also includes at least one computer-readable storage medium that stores the program therein. An object of one or more embodiments the present invention can be achieved by the at least one processor in the computer reading and executing the program stored in the storage medium. Examples of the at least one processor include central processing units (CPUs). Examples of the storage medium include “a non-transitory tangible medium” such as a tape, a disk, a card, a semiconductor memory, and a programmable logic circuit, as well as read only memories (ROMs). Each of the management servers 100 and 100a to 100c may further include a random access memory (RAM) or the like in which the program is loaded. The program can be supplied to or made available to the computer via any transmission medium (such as a communication network or a broadcast wave) which allows the program to be transmitted. Note that one or more embodiments of the present invention can also be achieved in the form of a computer data signal in which the program is embodied via electronic transmission and which is embedded in a carrier wave.

[Recap]

A server (management server 100, 100a, 100b, 100c) in accordance with Aspect 1 of the present invention is a management server including a communication device (server's communicating section 110) and a control device (control section 120, 120a, 120b, 120c), the communication device being configured to receive, from an electronic apparatus (terminal apparatus 10), a sound of a speech of a user, the sound of the speech being obtained by the electronic apparatus, and transmit, to the electronic apparatus, a response sound responding to the sound of the speech and cause the electronic apparatus to output the response sound, the control device being configured to detect, from the sound of the speech, a keyword that is a word or phrase implying narrowing down of a certain option group, and generate, based on the keyword, an option presenting sound which presents, to the user, one or more options included in the option group, the option presenting sound being the response sound.

According to conventional audio guidance, one way to present a plurality of options to a user is to audibly read all the options one by one. Such a configuration causes inconvenience because, especially in a case where the number of options is large, the time taken for the reading is long. As such, according to such a conventional technique, it is not realistic to present a plurality of options using audio.

In contrast, according to the above configuration, based on a rough indication by the user, the server narrows down options included in a certain option group to an option(s) which is/are to be presented to the user. Then, the server audibly presents the option(s) to the user via the electronic apparatus.

This makes it possible to narrow down the original option group while reflecting the user's desires (that is, reduce the number of options), and audibly present the obtained option(s) to the user. As such, it is possible to audibly present an option(s) that suits user's desires, while maintaining convenience without using a display device.

A server in accordance with Aspect 2 of the present invention (management server 100a, 100b, 100c) may be configured such that, in Aspect 1, the control device (control section 120, 120a, 120b, 120c) is configured to analyze the sound of the speech to identify content of the speech, determine, based on the content of the speech thus identified, whether or not to carry out presentation of one or more options included in the option group to the user, and generate the option presenting sound if it is determined to carry out presentation of one or more options included in the option group to the user.

According to the above configuration, it is possible to determine whether or not to carry out generation of an option presenting sound, based on the identified content of the speech. This makes it possible to present an option(s) when deemed appropriate during the conversation.

A server in accordance with Aspect 3 of the present invention may be configured such that, in Aspect 2, whether or not to carry out presentation of one or more options in the option group to the user is determined based on one or more kinds of information concerning the user or an environment around the user, the one or more kinds of information being obtained by at least one of the server and the electronic apparatus. Examples of the one or more kinds of information include the temperature of a room, weather, content of a speech of the user, history of selected options, operational status of some other equipment present near the user (e.g., settings of air conditioner), and the like.

According to the above configuration, it is possible to present an option(s) when deemed appropriate and in appropriate circumstances, based on the flow of conversation and the one or more kinds of information.

A server in accordance with Aspect 4 of the present invention (management server 100b, 100c) may be configured such that, in Aspect 3, whether or not to carry out presentation of one or more options in the option group to the user is determined based on a history of the user's selection of options in the option group, the history serving as one of the one or more kinds of information. This configuration makes it possible to present, to the user, an option(s) that is/are highly likely to suit the user's desires.

A server in accordance with Aspect 5 of the present invention may be configured such that, in Aspect 3 or 4: one option is selected from the option group based on at least one of the keyword, the content of the speech, and the one or more kinds of information; and the option presenting sound, which presents the one option to the user, is generated as the response sound.

According to the above configuration, it is possible to select one option based on the flow of conversation and the one or more kinds of information, and present the selected option to the user. This makes it possible to reduce the number of conversations between the user and the electronic apparatus, and thus possible to shorten the time taken for the user to select a specific option.

A server in accordance with Aspect 6 of the present invention (management server 100, 100a, 100b, 100c) may be configured such that, in Aspects 1 to 4, if the number of options resulted from the narrowing down of the option group based on the keyword is equal to or more than a predetermined number, an option-narrowing prompting sound is generated as the response sound, the option-narrowing prompting sound prompting the user to speak another keyword that enables further narrowing down of the options.

According to the above configuration, it is possible to narrow down the option group step by step, through the repetitive conversations between the user and the electronic apparatus. This makes it possible to present a reduced number of options to the user.

A server in accordance with Aspect 7 of the present invention may be configured such that, in Aspect 6, if the number of options resulted from the narrowing down of the option group is two or more, a sound indicative of one of the options resulted from the narrowing down of the option group is added at an end of the option-narrowing prompting sound generated as the response sound.

According to the above configuration, it is possible to narrow down the option group to a few options and, at the same time, possible to present one of these few options first. This makes it possible, assuming that the user selects the presented option, to reduce the number of conversations between the user and the electronic apparatus. In addition, since the one option is audibly presented at the end of the option-narrowing prompting sound, the user does not so much feel that he/she is forced to select the one option.

A server in accordance with Aspect 8 of the present invention (management server 100c) may be Configured such that, in Aspects 2 to 7: whether or not the sound of the speech contains an instruction to present another option other than an option(s) contained in a previously-generated option presenting sound is determined; and if it is determined that the sound of the speech contains an instruction to present another option, then the option presenting sound, which includes another option other than an option(s) contained in the previously-generated option presenting sound, is generated as the response sound. According to this configuration, the server is capable of, when the user wishes another option other than the option(s) presented by the server, receiving an instruction to present a different option. This improves convenience for the user.

An electronic apparatus in accordance with Aspect 9 of the present invention is an electronic apparatus including: a sound input section (microphone 11) configured to obtain a sound of a speech of a user; a sound output section (speaker 13) configured to output a response sound responding to the sound of the speech; and a control device (control section 120, 120a 120b, 120c), the control device being configured to detect, from the sound of the speech obtained by the sound input section, a keyword that is a word or phrase implying narrowing down of a certain option group, and generate, based on the keyword, an option presenting sound which presents, to the user, one or more options included in the option group, the option presenting sound being the response sound. This configuration brings about effects similar to those obtained by Aspect 1.

A control device in accordance with Aspect 10 of the present invention (control section 120, 120a, 120b, 120c) is a control device configured to control an electronic apparatus (terminal apparatus 10) including: a sound input section (microphone 11) configured to obtain a sound of a speech of a user; and a sound output section (speaker 13) configured to output a response sound responding to the sound of the speech, the control device including: a keyword detecting section (related term determining section 122, 122a) configured to detect, from the sound of the speech obtained by the sound input section, a keyword that is a word or phrase implying narrowing down of a certain option group, and a response generating section (123, 123a, 123b, 123c) configured to generate, based on the keyword, an option presenting sound which presents, to the user, one or more options included in the option group, the option presenting sound being the response sound. This configuration brings about effects similar to those obtained by Aspect 1.

A method of controlling an electronic apparatus in accordance with Aspect 11 of the present invention is a method of controlling an electronic apparatus that includes: a sound input section (microphone 11) configured to obtain a sound of a speech of a user; and a sound output section (speaker 13) configured to output a response sound responding to the sound of the speech, the method including: a keyword detecting step including detecting, from the sound of the speech obtained by the sound input section, a keyword that is a word or phrase implying narrowing down of a certain option group, and a response generating step including generating, based on the keyword, an option presenting sound which presents, to the user, one or more options included in the option group, the option presenting sound being the response sound. This configuration brings about effects similar to those obtained by Aspect 1.

The control device according to one or more embodiments of the present invention may be realized by a computer. In this case, the present invention encompasses: a control program for the control device which program causes a computer to operate as the foregoing sections (software elements) of the control device so that the control device can be realized by the computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

10 Terminal apparatus (Electronic apparatus)
11 Microphone (Sound input section)
13 Speaker (Sound output section)
100, 100a to 100c Management server (Server)
110 Server's communicating section (Communication device)
120, 120a to 120c Control section (Control device)
122, 122a Related term determining section (Keyword detecting section)
123, 123a to 123c Response generating section

1. A management server comprising a communication device and a control device,
the communication device being configured to
receive, from an electronic apparatus, a sound of a speech of a user, the sound of the speech being obtained by the electronic apparatus, and
transmit, to the electronic apparatus, a response sound responding to the sound of the speech and cause the electronic apparatus to output the response sound,
the control device being configured to
detect, from the sound of the speech, a keyword that is a word or phrase implying narrowing down of a certain option group, and
generate, based on the keyword, an option presenting sound which presents, to the user, one or more options included in the option group, the option presenting sound being the response sound.

2. The management server according to claim 1, wherein the control device is configured to
analyze the sound of the speech to identify content of the speech,
determine, based on the content of the speech thus identified, whether or not to carry out presentation of one or more options included in the option group to the user, and
generate the option presenting sound if it is determined to carry out presentation of one or more options included in the option group to the user.

3. The management server according to claim 2, wherein whether or not to carry out presentation of one or more options in the option group to the user is determined based on one or more kinds of information concerning the user or an environment around the user, the one or more kinds of information being obtained by at least one of the management server and the electronic apparatus.

4. The management server according to claim 3, wherein whether or not to carry out presentation of one or more options in the option group to the user is determined based on a history of the user's selection of options in the option group, the history serving as one of the one or more kinds of information.

5. The management server according to claim 3, wherein: one option is selected from the option group based on at least one of the keyword, the content of the speech, and the one or more kinds of information; and the option presenting sound, which presents the one option to the user, is generated as the response sound.

6. The management server according to claim 1, wherein, if the number of options resulted from the narrowing down of the option group based on the keyword is equal to or more than a predetermined number, an option-narrowing prompting sound is generated as the response sound, the option-narrowing prompting sound prompting the user to speak another keyword that enables further narrowing down of the options.

7. The management server according to claim 6, wherein, if the number of options resulted from the narrowing down of the option group is two or more, a sound indicative of one of the options resulted from the narrowing down of the option group is added at an end of the option-narrowing prompting sound generated as the response sound.

8. The management server according to claim 2, wherein:
whether or not the sound of the speech contains an instruction to present another option other than an option(s) contained in a previously-generated option presenting sound is determined; and
if it is determined that the sound of the speech contains an instruction to present another option, then the option presenting sound, which includes another option other than an option(s) contained in the previously-generated option presenting sound, is generated as the response sound.

9. An electronic apparatus comprising: a sound input section configured to obtain a sound of a speech of a user; a sound output section configured to output a response sound responding to the sound of the speech; and a control device,
the control device being configured to
detect, from the sound of the speech obtained by the sound input section, a keyword that is a word or phrase implying narrowing down of a certain option group, and
generate, based on the keyword, an option presenting sound which presents, to the user, one or more options included in the option group, the option presenting sound being the response sound.

10. A control device configured to control an electronic apparatus including: a sound input section configured to obtain a sound of a speech of a user; and a sound output section configured to output a response sound responding to the sound of the speech,
the control device comprising:
a keyword detecting section configured to detect, from the sound of the speech obtained by the sound input section, a keyword that is a word or phrase implying narrowing down of a certain option group, and
a response generating section configured to generate, based on the keyword, an option presenting sound which presents, to the user, one or more options included in the option group, the option presenting sound being the response sound.

11. A method of controlling an electronic apparatus that includes: a sound input section configured to obtain a sound of a speech of a user; and a sound output section configured to output a response sound responding to the sound of the speech, the method comprising:
a keyword detecting step comprising detecting, from the sound of the speech obtained by the sound input section, a keyword that is a word or phrase implying narrowing down of a certain option group, and
a response generating step comprising generating, based on the keyword, an option presenting sound which presents, to the user, one or more options included in the option group, the option presenting sound being the response sound.
